(19) United States
(12) Patent Application Publication
(10) Pub. No.: US 2011/0006451 A1
(43) Pub. Date: Jan. 13, 2011

(54) METHOD OF PRODUCING A DENTAL CERAMIC PRODUCT

(75) Inventors: Fredrik Adilstam, Tyreso (SE); Mattias Iverhed, Knivsta (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE SERVICES AG, Zürich-Flughafen (CH)

(21) Appl. No.: 12/808,668

(22) PCT Filed: Dec. 15, 2008
(86) PCT No.: PCT/EP08/10645

§ 371 Date: Jun. 16, 2010

(30) Foreign Application Priority Data
Dec. 17, 2007 (EP) 07024439.7

(51) Int. Cl. A61C 13/08

(52) U.S. Cl. 264/19

(57) ABSTRACT

Certain embodiments relate to a method of producing a dental ceramic product. In certain methods, a green body made of pressed ceramic powder and a binder is subjected to machining, such as milling, before the green body is sintered. The ceramic powder can contain about 2-6% by weight of a binder and the green body can be shaped to a corresponding shape of at least a part of a tooth to be restored.

### PRIORITY INFORMATION

This application is a U.S. National Phase of International Application No. PCT/EP2008/010645, filed on Dec. 15, 2008, which claims priority to European Application No. 07024439.7, filed Dec. 17, 2007, each of which is hereby incorporated by reference in its entirety.

### BACKGROUND

1. Field of the Invention

This application relates to methods of producing a dental ceramic product. Certain embodiments of the methods may be used in connection with the manufacturing of dental products such as, for example, dental implants, abutments, bridges, inlays or copings.

2. Description of the Related Art

For the production of a dental prosthesis, it has previously been suggested in U.S. patent application publication 2004/0119180 that a pre-sintered blank is first machined by a milling process and subsequently dense-sintered in a temperature range from 1200 to 1650° C. It is an object of certain embodiments disclosed herein to provide an improved method for making dental ceramic products.

### BRIEF DESCRIPTION OF THE DRAWINGS

FIG. 1 is a schematic representation of how a green body is machined by a tool such as a milling cutter, according to some embodiments.

FIG. 2 is a schematic representation of how two different tools may be used in some embodiments.

### DETAILED DESCRIPTION

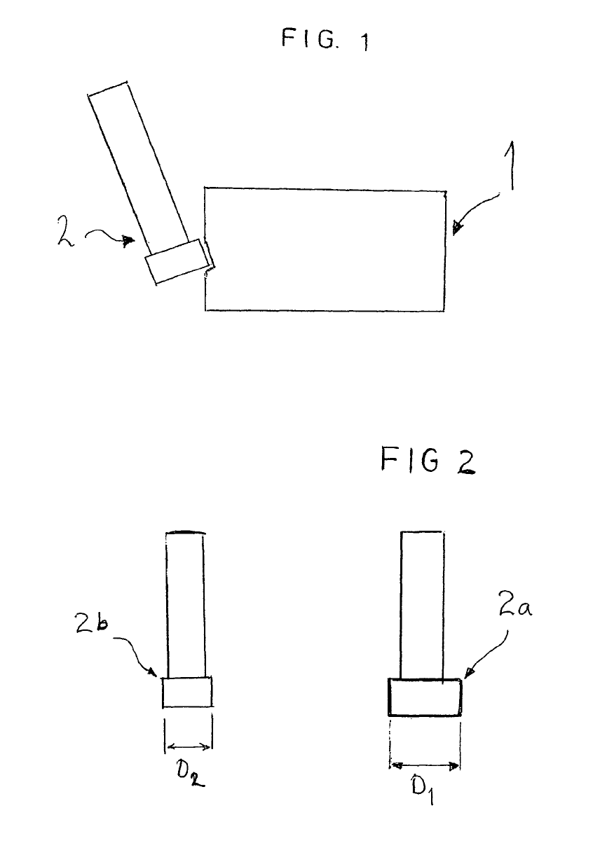

The present application relates to a method of producing dental ceramic products. Certain embodiments of the method comprise providing a green body 1 that has been obtained by pressing a ceramic powder that contains 2-6% by weight of a binder. With reference to FIG. 1, the green body 1 is then shaped to a shape corresponding to the shape of at least a part of a tooth to be restored. According to certain embodiments, the green body is shaped by machining the green body before the green body is subjected to a sintering operation such that the binder still remains in the green body. The machining operation can be made with a tool 2 that may be, for example, a milling cutter 2. The binder used in the green body may be, for example, polyvinyl alcohol (PVA), polyethylene glycol (PEG), polymethyl methacrylate (PMMA) or steric acid (SA).

In some embodiments, the green body 1 that has previously been obtained through pressing may suitably have been pressed at a pressure in the range of 180 MPa-220 MPa but could conceivably also have been pressed at other pressure levels. For example, the pressing may have been performed at pressures up to 300 MPa or even higher. As an example, it can be mentioned that the green body 1 may have been initially formed by pressing a ceramic powder that contains aluminium oxide and the pressure used may lie in the range of 195 MPa-205 MPa.

The machining of the green body 1 in certain embodiments may be performed by milling. Milling of the green body 1 may comprise an initial milling that is performed at a speed of 8000 rev/min-16000 rev/min and at a rate of advance from 1600 m/min-3000 m/min. For the initial milling, the speed of the milling may be, for example 9000 rev/min-15000 rev/min or 10000 rev/min-14000 rev/min while the rate of advance may be, for example 1850 m/min-2800 m/min or 1900 m/min-2300 m/min. such that, for example, the speed range of 9000 rev/min-15000 rev/min corresponds to a rate of advance in the range of 1850 m/min-2800 m/min.

The initial milling may then in certain embodiments be followed by a secondary milling that is performed at a speed of 12000 rev/min-22000 rev/min and at a rate of advance from 1600 m/min-3000 m/min. For example, suitable values for speed during the secondary milling may lie in the range of 13000 rev/min-20000 rev/min or in the narrower range of 14000 rev/min-18000 rev/min. The rate of advance may lie, for example, in the range of 1800 m/min-2800 m/min or in the narrower range of 1900 m/min-2400 m/min. It should be understood that the narrowing ranges for speed correspond in certain embodiments to narrowing ranges for the rate of advance.

According to some embodiments, the secondary milling may be followed by a third milling performed at a speed of 16000 rev/min-30000 rev/min and at a rate of advance of 2400 m/min-3700 m/min. For example, suitable values for speed during the third milling may lie in the range of 18000 rev/min-26000 rev/min at a rate of advance in the range of 2600 m/min-3500 m/min. The speed may also be chosen in the narrower ranges of 20000 rev/min-24000 rev/min at a rate of advance in the range of 2800 m/min-3300 m/min.

After the third milling, the green body 1 may be subjected to a final milling in certain embodiments that is performed at a speed of 22000 rev/min-35000 rev/min and at a rate of advance of 2400 m/min and 3700 m/min. For example, the speed of the milling may be in the range of 24000 rev/min-31000 rev/min at a rate of advance in the range of 2600 m/min-3500 m/min or the speed of the milling may be in the range of 25000 rev/min-30000 rev/min at a rate of advance in the range of 2800 m/min-3300 m/min.

According to certain embodiments disclosed herein, the initial milling can be made with a first milling cutter 2 having a diameter in the range of 4 mm-8 mm or 4 mm-6 mm. The secondary milling may be performed in some embodiments with a milling cutter 2 having a diameter that is smaller than that of the first milling cutter. For example, the secondary milling cutter 2 may have a diameter of 2 mm-3 mm. The final milling may be performed in certain embodiments with a milling cutter 2 having a diameter of about 1 mm.

The speeds given above and the values indicated for the milling cutters 2 have been found to give good results but other values are also possible.

According to certain embodiments, the milling performed may comprise of at least two steps, e.g., at least an initial milling and at least a final milling. Reference is now made to FIG. 2. In some embodiments, during the initial milling, a milling cutter 2a with a larger diameter D₁ may be used and a milling cutter 2b with a smaller diameter D₂ may be used during the final milling. It should thus be understood that, in the embodiment shown in FIG. 2, D₁>D₂. The reason is that for certain embodiments, during the initial milling, it is more important to remove unwanted material as quickly as possible. During the final milling, less material remains to be removed but the final milling is more important for the surface properties of the green body 1 (e.g., how even it becomes). For this reason, a milling cutter 2b with a smaller diameter can be used during final milling. Normally (but not necessarily), the final milling is also performed at a higher speed than the initial milling. The reason is that the higher speed is more suitable during the final milling when a very even surface is to be obtained. It can be added that it is possible to use only one milling cutter 2 and one single speed during the entire milling (e.g., the machining would comprise only one single milling). However, in certain embodiments, such a procedure would be more time-consuming and less cost-effective.

### Example Embodiment

A dental bridge was manufactured from a ceramic powder based on aluminium oxide and containing 3% by weight of a binder. In this case, the binder was PVA but it would of course have been possible to use another binder. A blank (e.g., a green body) was formed by cold isostatic pressing at a pressure of 200 MPa. An initial milling operation was performed with a milling cutter 2 having a diameter of 5 mm. The speed of the milling cutter 2 was 10500 rev/min and the rate of advance was 1900 m/min. The secondary milling was performed with a milling cutter 2 having a diameter of 2 mm and at a speed of 15500 rev/min and a rate of advance of 1950 m/min.

After this, the blank (e.g., the green body 1) was subjected to one more milling operation that was performed with a milling cutter 2 having a diameter of 1 mm. This milling operation was performed at a speed of 26000 rev/min at a rate of advance of 2900 m/min.

The surface of the green body 1 was then compared to the surface of a blank that had first been subjected to a pre-sintering treatment and then to milling. The comparison showed that the surface of the green body 1 that had been subjected to milling was visibly more even than the surface of the blank that had first been pre-sintered and then subjected to milling.

According to certain embodiments of the present invention, the green body 1 is first subjected to machining and after this, it may be subjected to sintering.

According to certain embodiments, when the green body 1 is subjected to machining while it still contains a binder, the green body 1 will not break so easily even though the machining is performed at high speeds that also allow a rational and cost-effective production. Additionally, in certain embodiments, the tools used will not wear out as quickly as when a sintered body is subjected to machining.

The ceramic powder used for the green body 1 may be, for example, aluminium oxide or zirconium oxide.

It is envisaged that, in practice, the machining method used will usually be milling but machining could also be performed by, for example, drilling or turning. It is also possible that different machining methods are combined. For example, the green body 1 could be subjected to both milling and drilling.

According to certain embodiments, during sintering, the binder in the ceramic material evaporates such that the binder can no longer contribute to holding the powder material together. For this reason, sintering in certain embodiments is performed after machining. This does not necessarily exclude that the green body 1 is subjected to some heating before the machining operation. However, such heating may not be so extensive that the binder disappears from the ceramic material since the ceramic material contains 2-6% by weight of the binder in certain embodiments.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

1. A method of producing a dental ceramic product, the method comprising:
providing a green body that has been obtained by pressing a ceramic powder, the ceramic powder containing a binder;
shaping the green body to a corresponding shape of at least a part of a tooth to be restored by milling the green body before the green body is subjected to a sintering operation such that the binder still remains in the green body while the green body is being milled; and
subjecting the green body to the sintering operation, wherein the binder in the ceramic powder of the green body evaporates during the sintering operation.

2. A method according to claim 1, wherein the milling comprises at least an initial milling and a final milling and wherein the final milling is performed at a higher speed than the initial milling.

3. A method according to claim 1, wherein the milling comprises at least an initial milling and a final milling and wherein a first milling cutter is used in the first milling and a second milling cutter is used in the final milling and wherein the second milling cutter used in the final milling has a smaller diameter than a diameter of the first milling cutter used in the initial milling.

4. A method according to claim 1, wherein the milling comprises:
a. an initial milling that is performed at a speed of 8000 rev/min-16000 rev/min and at a rate of advance from 1600 m/min-3000 m/min,
b. a secondary milling performed at a speed of 12000 rev/min-22000 rev/min and at a rate of advance from 1600 m/min-3000 m/min,
c. a third milling performed at a speed of 16000 rev/min-30000 rev/min and at a rate of advance of 2400 m/min-3700 m/min, and
d. a final milling performed at a speed of 22000 rev/min-35000 rev/min and at a rate of advance of 2400 m/min and 3700 m/min.

5. A method according to claim 4, wherein the initial milling is made with a first milling cutter having a diameter in the range of 4-8 mm and the secondary milling with a second milling cutter having a diameter that is smaller than the diameter of the first milling cutter.

6. A method according to claim 5, wherein the initial milling is made with the first milling cutter having a diameter of 4 mm-6 mm, the secondary milling with the second milling cutter having a diameter of 2 mm-3 mm and the final milling with a third milling cutter having a diameter of about 1 mm.

7. A method according to claim 1, wherein said providing the green body that has been obtained by pressing a ceramic powder comprises providing a green body that has been obtained by pressing a ceramic powder, the ceramic powder containing 2-6% by weight of a binder.

8. A method according to claim 1, wherein after the binder in the ceramic powder of the green body evaporates during the sintering operation, the binder no longer contributes to holding the ceramic powder together.
